(19) United States
(12) Patent Application Publication
(10) Pub. No.: US 2023/0156299 A1
(43) Pub. Date: May 18, 2023

(54) FINGERPRINTING A TELEVISION SIGNAL AND DISPLAYING INFORMATION CONCERNING A PROGRAM THAT IS BEING TRANSMITTED BY THE TELEVISION SIGNAL

(71) Applicant: OATS TECHNOLOGY, INC., Elmsford, NY (US)

(72) Inventors: Steven J. PONTILLO, Howard Beach, NY (US); Bruce ALLEN, Brooklyn, NY (US)

(73) Assignee: OATS TECHNOLOGY, INC., Elmsford, NY (US)

(21) Appl. No.: 17/960,272

(22) Filed: Oct. 5, 2022

Related U.S. Application Data
(60) Provisional application No. 63/278,611, filed on Nov. 12, 2021.

(51) Int. Cl. H04N 21/8549; H04N 21/81; H04N 21/41; H04N 21/478

(52) U.S. Cl. CPC H04N 21/8549; H04N 21/8126; H04N 21/4104; H04N 21/478

(57) ABSTRACT

There is provided a process that includes (a) receiving an identification of a television (TV) network, (b) obtaining a descriptor of a sporting event that is being transmitted by the TV network, (c) obtaining gambling statistics concerning the sporting event, and (d) sending the gambling statistics to a device for presentation on a target display. There is also provided a system that performs the process, and a storage device that contains instructions that cause a processor to perform the process.

### BACKGROUND OF THE DISCLOSURE

### 1. Field of the Disclosure

The present disclosure relates to processing of a television (TV) signal, and more particularly, to fingerprinting the TV signal and displaying information concerning a program that is being transmitted on the TV signal.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

There is a need for a technique that determines what TV program(s) is/are being shown on one or many TV screens, and creates and displays relevant information about the program(s) (e.g., betting odds, program information) on a second display.

### SUMMARY OF THE DISCLOSURE

It is an object of the present disclosure to provide for a technique that determines what TV program(s) is/are being shown on one or many TV screens, and creates and displays relevant information about the program(s) (e.g., betting odds, program information) on a second display.

To address this object, in the present document there is provided a process that includes (a) receiving an identification of a television (TV) network, (b) obtaining a descriptor of an event that is being transmitted by the TV network, i.e., a televised event, (c) obtaining information concerning the event, and (d) sending the information to a device for presentation on a target display. There is also provided a system that performs the process, and a storage device that contains instructions that cause a processor to perform the process.

In an exemplary embodiment, the televised event is a sporting event. Accordingly, the process includes (a) receiving an identification of a television (TV) network, (b) obtaining a descriptor of a sporting event that is being transmitted by the TV network, (c) obtaining gambling statistics concerning the sporting event, and (d) sending the gambling statistics to a device for presentation on a target display. There is also provided a system that performs the process, and a storage device that contains instructions that cause a processor to perform the process.

### BRIEF DESCRIPTION OF THE DRAWINGS

FIG. 1 is a block diagram of a system for fingerprinting a TV signal and displaying information concerning a program that is being transmitted by the TV signal.

FIG. 2 is a block diagram of a Broadcast ID Device in the system of FIG. 1.

FIG. 3 is a block diagram of an Analytics System in the system of FIG. 1.

FIG. 4 is a block diagram of a Display Device in the system of FIG. 1.

FIG. 5 is a block diagram of a mobile camera phone that has an application installed therein for utilization in the system of FIG. 1.

FIG. 6 is a block diagram of a portion of the system for a scenario in which user is using a mobile camera phone.

FIG. 7 is a collection of flowcharts of a session showing processes performed by a Broadcast ID Device, an Analytics System, and a Display Device.

FIG. 8 is a flowchart of a process performed by a mobile camera phone.

A component or a feature that is common to more than one drawing is indicated with the same reference number in each of the drawings.

### DESCRIPTION OF THE DISCLOSURE

Fingerprinting is a process of acquiring video or audio samples of a TV program and extracting certain attributes to create a unique sample ID. The sample ID can be compared to a reference database to determine a match to a TV channel or a programming stream.

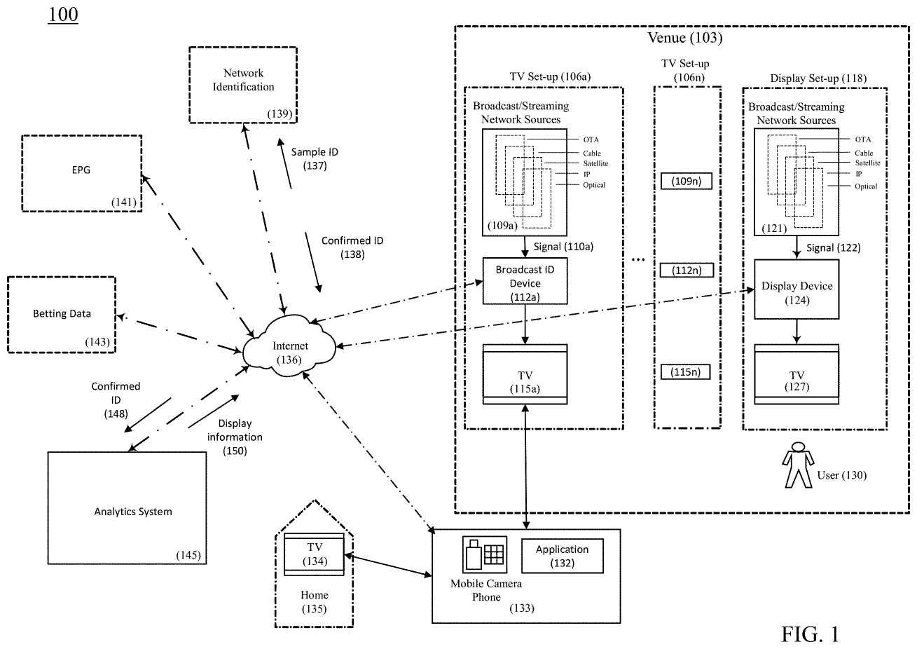

FIG. 1 is a block diagram of a system, namely system 100, for fingerprinting a TV signal and displaying information concerning a program that is being transmitted by the TV signal. In one aspect, system 100 displays graphical information on a dedicated TV about televised events taking place on adjacent or proximity TVs in a multiscreen venue. In another aspect, system 100 allows a user to use a mobile camera phone to execute an application that captures an event on a TV, in either the venue or at a home, and displays graphical information related to the event thus providing an augmented reality experience. In the present document, system 100 is described by way of example as displaying gambling statistics concerning a sporting event that is being presented on a TV.

In system 100:
(a) TV monitoring devices, referred to herein as Broadcast ID devices, gather, in real time, data such as device MAC address, geographic location, venue location, surrounding or proximity TV's and signal. A sample ID is created from the signal by sampling TV audio or video. The sample ID is compared to a live database of monitored channels to identify a name of the network that is transmitting the signal. The TV network name is then sent to an analytics system that obtains additional information concerning programs currently being shown on the named TV network. The phrase “real time” as used herein means that from the perspective of a person, an action appears to be immediate, or nearly so, e.g., within a few seconds.
(b) The analytics system acquires data from multiple sources, including the Broadcast

ID devices, an electronic program guide (EPG), and a betting data service. The analytics system analyzes data associated with the TV channels that are playing at each specific geographic location to determine what data to send to a display device for display on a TV.
(c) The display device receives data from the analytics system, populates locally stored graphical templates, and plays stored or live streamed content on the TV's screen.
(d) A mobile camera phone includes an application to determine what TV event a user is watching. The user points the mobile camera phone at the TV, and the application samples audio or video and creates a sample ID. The sample ID is compared to a live database of monitored channels to identify a name of the network that is transmitting the TV event. The TV network name is then sent to an analytics system that obtains additional information concerning programs currently being shown on the named TV network, and the application displays the additional information on the mobile camera phone. The application can be used at either a business venue or a non-business venue, e.g., the user's home.

The description of FIG. 1, below, provides an abbreviated, introductory description of the operation of system 100. Further details are provided in descriptions of subsequent drawings.

System 100 includes a venue 103, Network Identification 139, an EPG 141, Betting Data 143, an Analytics System 145, a home 135, and a mobile camera phone 133. Various components of system 100 communicate with one another via Internet 136, and such communications may be conducted via paths that include wireless channels or wired channels, e.g., Wi-Fi, Ethernet, and cellular/mobile channels for smartphone communications for Internet access.

Venue 103, e.g., a business venue such as a bar or restaurant, includes a TV set-up 106a, a TV set-up 106n, and a display set-up 118.

TV set-up 106a includes Broadcast/Streaming Network Sources 109a, a Broadcast ID device 112a, and a TV 115a.

Display set-up 118 includes Broadcast/Streaming Network Sources 121, a Display Device 124, and a TV 127.

Broadcast/Streaming Network Sources 109a is a source of a TV program, which is represented as signal 110a. Broadcast/Streaming Network Sources 109a may include, for example, over-the-air (OTA), cable, satellite, internet (IP), or optical sources. Signal 110a can be in any TV format, e.g., ultra-high definition, high-definition or standard definition over high bandwidth digital multimedia interface (HDMI), component or composite video and optical, and may include digital audio or analog audio. The digital audio or analog audio can be derived from cable/OTA/streaming devices. For purpose of example, assume that signal 110a is a broadcast of a sporting event.

Broadcast ID device 112a receives signal 110a and forwards it to TV 115a. In practice, if signal 110a is in an optical, digital audio or analog audio format, TV 115a would be optional, as TV 115a would not ordinarily be used if signal 110a is in an optical, digital audio or analog audio format. Broadcast ID device 112a extracts audio or video of the TV program from signal 110a, based thereon creates a sample ID 137, and sends sample ID 137 to Network Identification 139.

Network Identification 139 receives sample ID 137, and based thereon, identifies a TV network that is transmitting the TV program, thus yielding a confirmed ID 138, and sends confirmed ID 138 to Broadcast ID Device 112a. In the present example, confirmed ID 138 identifies the TV network that is transmitting the sporting event.

Broadcast ID Device 112a receives confirmed ID 138 and in turn, sends a confirmed ID 148, to Analytics System 145. Confirmed ID 148 includes the TV network identification and also includes information about Broadcast ID Device 112a, such as its MAC address.

In an alternative embodiment, Broadcast ID Device 112a sends Sample ID 137 to Analytics System 145. Analytics System 145 sends Sample ID 137 to Network Identification 139. Network Identification 139 receives sample ID 137, and based thereon, identifies a TV network that is transmitting the TV program, thus yielding a confirmed ID 138, and sends confirmed ID 138 to Analytics System 145.

In another alternative embodiment, Broadcast ID Device 112a sends Sample ID 137 to Network Identification 139. Network Identification 139 receives sample ID 137, and based thereon, identifies a TV network that is transmitting the TV program, thus yielding a confirmed ID 138, and sends confirmed ID 138 to Analytics System 145.

Analytics System 145 obtains, from EPG 141 and Betting Data 143, information about the TV program that is being transmitted by the TV network. EPG 141 provides descriptors of programming events that are scheduled on the TV network, including a descriptor of the sporting event. Betting Data 143 provides gambling statistics specific to the sporting event scheduled or currently being shown. Analytics System 145 sends the information, in the form of display information 150, to Display Device 124. In the present example, display information 150 is information, e.g., gambling statistics concerning the sporting event that is being presented on TV 115a.

As mentioned above, display set-up 118 includes Broadcast/Streaming Network Sources 121. Broadcast/Streaming Network Sources 121 are similar to Broadcast/Streaming Network Sources 109a, and provides a TV signal, namely signal 122, to Display Device 124.

Display Device 124 has two modes of operation. In the first mode of operation, Display Device 124 routes signal 122 to TV 127. In a second mode of operation, Display Device 124 internally creates a graphical representation of display information 150 on TV 127, and in the present example, the information concerns the sporting event that is being presented on TV 115a. Accordingly, when Display Device 124 is in its second mode of operation, a user 130 can watch the sporting event on TV 115a and view corresponding gambling statistics on TV 127.

In an alternative embodiment, Display Device 124, and Broadcast ID Device 112a can provide the same functionality and therefore be interchanged.

TV set-up 106n is similar to TV set-up 106a, and includes Broadcast/Streaming Network Sources 109n, a Broadcast ID Device 112n, and a TV 115n, which operate similarly to Broadcast/Streaming Network Sources 109a, Broadcast ID Device 112a, and TV 115a, respectively. Accordingly, ID Device 112n will communicate with components via Internet 136, and Display Device 124 will also display on TV 127, information concerning a TV program or an event that is being presented on TV 115n.

As explained below, system 100 is informed of locations of TVs 115a and 115n relative to the location of TV 127, and thus relative to one another, so that TV 127 can present, on its display, information that is relevant to what is being displayed on TVs 115a and 115n. For example, if TVs 115a and 115n are mounted on a wall, and TV 115a is situated to the left of TV 127, and TV 115n to the right of TV 127, TV 127 will display information concerning the program on TV 115a on the left side of TV 127's display, and information concerning the program on 115n on the right side of TV 127's display Alternatively, instead of TV 127 concurrently presenting information concerning TV 115a and 115n, TV 127 can present the information in time slices, for example, in a cyclical manner, present information concerning TV 115a for several seconds, and then present information concerning TV 115n for several seconds.

Although venue 103 is shown as having two TV set-ups, i.e., TV set-ups 106a and 106n, in practice, venue 103 may have any desired number of TV set-ups, and thus a plurality of TVs, and accordingly, Display Device 124 will display, on TV 127, information concerning TV programs or events being presented on the plurality of TVs.

Also, in practice, system 100 may include many venues configured similarly to venue 103, having devices similar to Broadcast ID Device 112a and Display Device 124 that engage in communication with Analytics System 145.

Another aspect of system 100 utilizes mobile camera phone 133, e.g., a phone or other communication device being used by user 130. Mobile camera phone 133 includes an application 132 that, when executed, (a) captures, from TV 115a, audio or video concerning a TV program, (b) communicates with Network Identification 139 and Analytics System 145 to obtain display information 150, and (c) and presents, on a display of mobile camera phone 133, information concerning the TV program. Application 132 could similarly capture audio or video from a TV program being presented on TV 134 in home 135, and thereafter present on the display of mobile camera phone 133, information concerning the TV program being presented on TV 134. Application 132 will also provide an ability to overlay betting data on a streamed live event being captured by user 130 on mobile camera phone 133 to create an augmented reality experience.

Moreover, TV 134 need not be situated in home 135, but instead, at any location. As such, mobile camera phone 133, by way of execution of application 132, can operate in a venue such as a bar or restaurant that may or may not include Broadcast ID device 112a yet still allow user 130 to view information about a program that is being presented on a TV in the bar or restaurant.

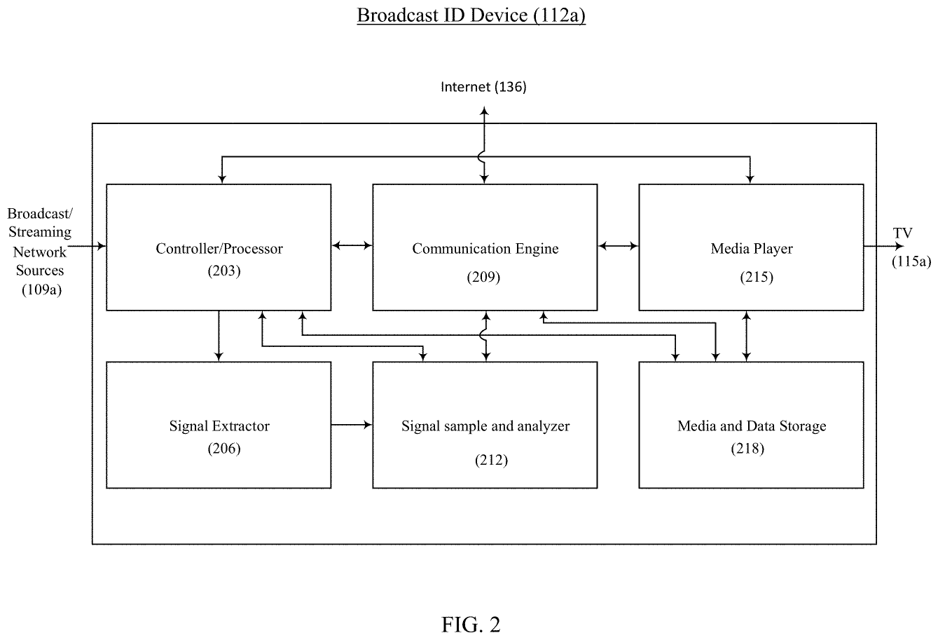

FIG. 2 is a block diagram of Broadcast ID Device 112a. Broadcast ID Device 112a includes several modules, namely a controller/processor 203, a signal extractor 206, a communication engine 209, a signal sample and analyzer 212, a media player 215, and media and data storage 218.

The term “module” is used herein to denote a functional operation that may be embodied either as a stand-alone component or as an integrated configuration of a plurality of subordinate components. Thus, a module may be implemented as a single module or as a plurality of sub-ordinate modules that operate in cooperation with one another.

Controller/Processor 203 communicates with all of the other modules in Broadcast ID Device 112a. The communications include device configurations and software programming stacks. Controller/Processor 203 receives signal 110a from Broadcast/Streaming Network Sources 109a, and routes signal 110a to signal extractor 206.

Signal extractor 206 decodes signal 110a, e.g., decodes an HDMI signal's audio or video, and provides the decoded signal to signal sample and analyzer 212.

Signal sample and analyzer 212 creates sample ID 137 for the specific sample of signal 110a, and sends sample ID 137to communication engine 209.

Communication engine 209 sends sample ID 137 via Internet 136 to Network Identification 139. Network Identification 139 identifies a TV network that is transmitting the TV program, thus yielding a confirmed ID 138 sends confirmed ID 138 back to Broadcast ID Device 112a. Network Identification 139 provides the TV network identification that matched sample ID 137 or a “no match” ID if no match was found. Thereafter, Broadcast ID Device 112a sends its MAC address and the confirmed TV network identification on confirmed ID 148 to the Analytics System 145 for processing.

, In an alternative embodiment, Communication engine 209 sends sample ID 137 and MAC address via Internet 136 to Analytics System 145. Analytics System 145 sends Sample ID 137 via Internet 136 to Network Identification 139. Network Identification 139 identifies a TV network that is transmitting the TV program, thus yielding a confirmed ID 138, and sends confirmed ID 138 back to Analytics System 145. Network Identification 139 provides the TV network identification that matched sample ID 137 or a “no match” ID if no match was found.

In another alternative embodiment, Communication engine 209 sends sample ID 137 and MAC address via Internet 136 to Network Identification 139. Network Identification 139 identifies a TV network that is transmitting the TV program, thus yielding a confirmed ID 138, and sends confirmed ID 138 with MAC address to Analytics System 145. Network Identification 139 provides the TV network identification that matched sample ID 137 or a “no match” ID if no match was found.

Media and data storage 218 provides for storage of media, graphical elements, and local advertising banners and commercials.

Media player 215 selectively routes, to TV 115a, either (a) live content, i.e., in signal 110a, from Broadcast/Streaming Network Sources 109a, (b) live content via Internet 136, or (c) data from media and data storage 218.

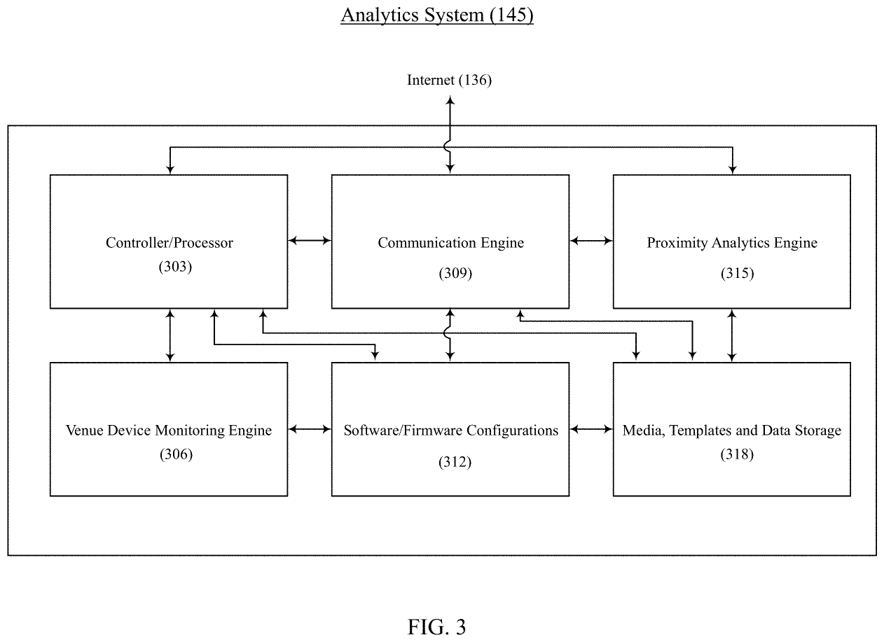

FIG. 3 is a block diagram of Analytics System 145. Analytics System 145 includes several modules, namely, a controller/processor 303, a venue device monitoring engine 306, a communication engine 309, software/firmware configurations 312, a proximity analytics engine 315, and media, templates, and data storage 318.

Analytics System 145 provides for monitoring and health of Broadcast ID Device 112a, Broadcast ID Device 112n, and Display Device 124.

Controller/Processor 303 communicates with all the other modules within Analytics System 145, and also with Betting Data 143, EPG 141, Networking Identification 139, Broadcast ID Device 112a, and Display Device 124.

Communications engine 309 provides for communications, via Internet 136, with Betting Data 143, EPG 141, Broadcast ID Device 112a, Broadcast ID Device 112n, and Display Device 124.

Proximity analytics engine 315 collects and maintains information concerning venue 103 relating to TVs 115a and 115n, and TV 127, and the proximity of TVs 115a and 115n to TV 127. In this regard, proximity analytics engine 315 is interested in the locations of TVs 115a and 115n relative to the location of TV 127, so that, as mentioned above, TV 127 can present, on its display, information that is relevant to what is being displayed TVs 115a and 115n. Each of the devices are identified by MAC address, which associates all of the relevant data for the analytic process.

Venue device monitoring engine 306 receives from Broadcast ID Device 112a, the network identification of the program that is being displayed on TV 115a along with Broadcast ID Device 112a 's unique parameters such as MAC address and health. Controller/Processor 303 obtains information from EPG 141 and Betting Data 143, and groups relevant information for venue 103 and Display Device 124. All information is sent via communications engine 309 and includes betting data, templates, and images for Display Device 124. Communications between components of system 100 are conducted in real time so that if TV 115a is tuned to a different channel of Broadcast/Streaming Network Sources 109a, Broadcast ID Device 112a will inform Analytics System 145 (via Sample ID 137and Confirmed ID 138), and Analytics System 145 will send, to Display Device 124, new information specific to the newly tuned channel of Broadcast/Streaming Network Sources 109a.

Software/firmware configurations 312 maintains and standardizes software/firmware configurations for Broadcast ID Device 112a and Display Device 124. This includes automatic configurations due to loss of power or device interrupt.

Media, Templates and Data Storage 318 serves multiple purposes. In the example of sporting events, data is collected from EPG 141 for future scheduled events. Graphical templates, content (e.g., commercials, videos, photos) are sent to Display Device 124 prior to when they will need to be displayed.

Thus, Analytics System 145 collects information from Broadcast ID Device 112a, Display Device 124, EPG 141, and Betting Data 143. Venue Device Monitoring Engine 306 verifies all units are operational and functional. Proximity Analytics Engine 315 determines what information should be transmitted via Internet 136 to Display Device 124 and shown on TV 127. At the conclusion of the live events, Display Device 124 can be deactivated via Internet 136 and switched back to Broadcast/Streaming Network Sources 121 to display signal 122 on TV 127.

As mentioned above, in practice, system 100 may include many venues configured similarly to venue 103. Accordingly, Analytics System 145 will provide monitoring and health for Broadcast ID Devices that are similar to Broadcast ID Device 112a, and Display Devices that are similar to Display Device 124, in each of the many venues.

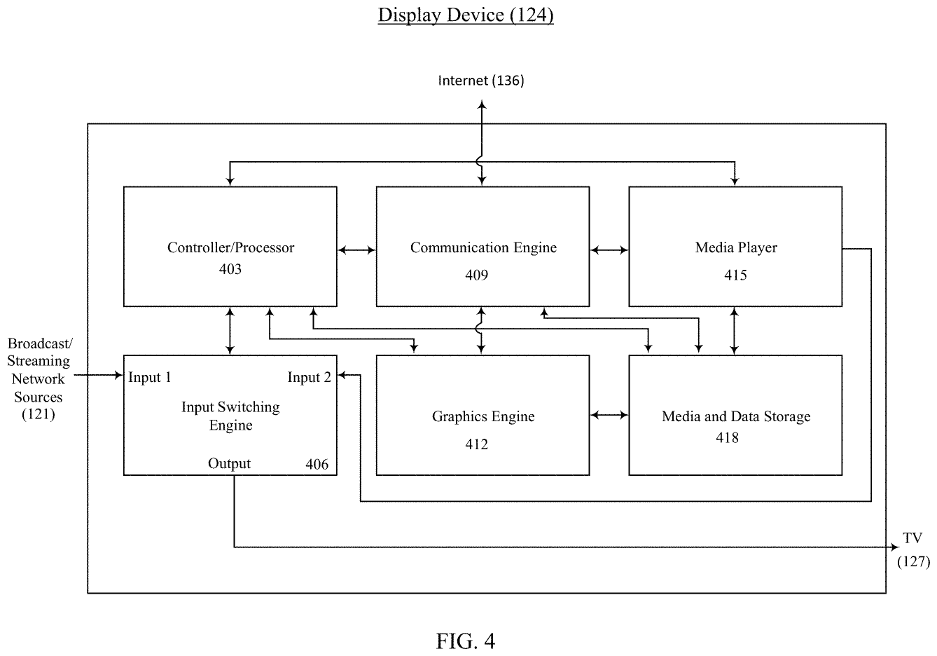

FIG. 4 is a block diagram of Display Device 124. Display Device 124 includes several modules, namely, a controller/processor 403, an input switching engine 406, a communication engine 409, a graphics engine 412, a media player 415, and media and data storage 418.

Controller/processor 403 communicates with all the other modules within Display Device 124. The communications include device configurations and software programming stacks.

Communication engine 409 receives relevant information, i.e., display information 150, from Analytics System 145 on a real time basis via Internet 136.

Media and data storage 418 stores templates and data that are sent by Analytics System 145.

Graphics engine 412 retrieves the templates and data from media and data storage 418 and prepares them for presentation on TV 127. As mentioned above, TV 127 correlates the presentation of information on its display to programs being presented on TV 115a and 115n.

Media Player 415 can play locally stored content from media and data storage 418, or stream content that it obtains via the Internet 136 through communication engine 409.

Input switching engine 406 routes, to TV 127, either signal 122 from Broadcast/Streaming Network Sources 121, or (b) content from graphics engine 412 and media player 415, e.g., information concerning a program that is being presented on TV 115a.

Thus, Display Device 124 provides, to TV 127, consolidated information received from Analytics System 145, which includes information from Broadcast ID Device 112a, specifics of the scheduled live events from the EPG 141 and Betting Data 143 statistics, all of which relate to what is being shown on TV 115a.

In an alternative embodiment, Display Device 124, and Broadcast ID Device 112a provide identical functionality and therefore interchangeable hardware.

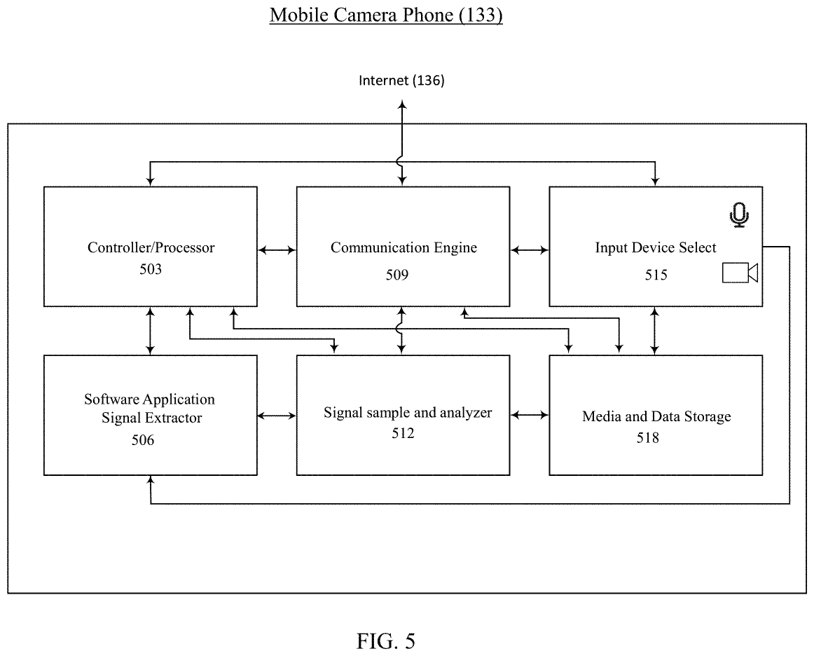

FIG. 5 is a block diagram of mobile camera phone 133 and includes several modules, namely, a controller/processor 503, an input device select 515, a communication engine 509, a software application signal extractor 506, a signal sample and analyzer 512, and media and data storage 518.

Software application and signal extractor 506 allows user 130 to select signal capture mode via input device select 515. Software application signal extractor 506 sends a captured audio or video signal to signal sample and analyzer 512.

Signal Sample and Analyzer 512 analyzes the captured signal and sends sample ID 137 to Network Identification 139 via Communication Engine 509 and Internet 136. In practice, mobile camera phone 133 may access Internet 136 via a mobile carrier's network.

Network Identification 139 sends confirmed ID 138, which includes network identification, to mobile camera phone 133. Communications engine 509 sends relevant data including network identification to Analytics System 145. Analytics System 145 sends display information 150 to mobile camera phone 133 for displaying.

In an alternative embodiment, Signal Sample and Analyzer 512 analyzes the captured signal and sends sample ID 137 to Analytics System 145 via Communication Engine 509 and Internet 136. Analytics System 145 sends Sample ID 137 to Network Identification 139 via Internet 136. Network Identification 139 sends Confirmed ID 138 to Analytics System 145. Analytics System 145 sends display information 150 to mobile camera phone 133 for displaying.

In another alternative embodiment, Signal Sample and Analyzer 512 analyzes the captured signal and sends sample ID 137 to Network Identification 139 via Communication Engine 509 and Internet 136. Network Identification 139 sends Confirmed ID 138 to Analytics System 145. Analytics System 145 sends display information 150 to mobile camera phone 133 for displaying.

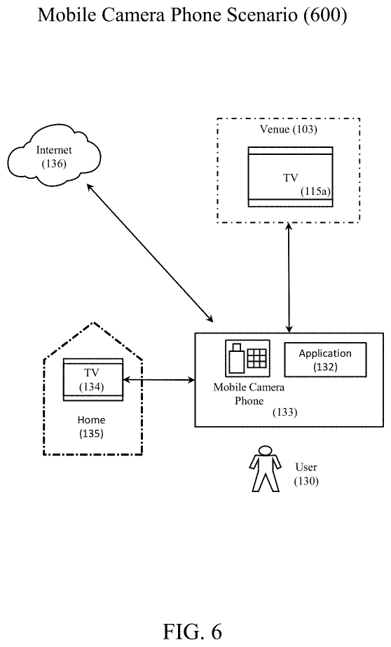

FIG. 6 is a block diagram of a portion of system 100 for a scenario 600 in which user 130 is using mobile camera phone 133.

Mobile camera phone 133 is a device such as a smart phone or a tablet that includes a camera to capture video streams, a microphone to capture audio, Internet connectivity and a display. It also includes a processor (not shown) and a memory (not shown) that contains data and program code, i.e., instructions, that control the processor. In this regard, the memory includes application 132, which controls the processor to perform operations described herein on behalf of mobile camera phone 133.

Prior to use of application 132, user 130 downloads application 132 into the memory of mobile camera phone 133, and allows permissions application 132 to access location services, the camera, and the microphone of mobile camera phone 133. User 130 runs application 132 and selects video or audio sampling so that system 100 can determine what user 130 is watching on TV 134 at home 135, or TV 115a at venue 103. Mobile camera phone 133 sends sample ID 137 via Internet 136 to Network Identification 139 for verification. Mobile camera phone 133 receives confirmed ID 138 and sends data i.e., confirmed ID 148, to Analytics System 145. Analytics System 145 obtain information from EPG 141 and Betting Data 143, and formats and sends display information 150, which include relevant data with graphical elements, to mobile camera phone 133 for presentation on the display of mobile camera phone 133. Analytics System 145 will continue to update mobile camera phone 133 until user 130 terminates application 132 or uses application 132 to capture another video or audio sample.

In an alternative embodiment, mobile camera phone 133 sends sample ID 137 via Internet 136 to Analytics System 145. Analytics System 145 sends sample ID 137 to Network Identification 139. Network Identification 139 sends Confirmed ID 138 to Analytics System 145. Analytics System 145 obtains information from EPG 141 and Betting Data 143, and formats and sends display information 150, which includes relevant data with graphical elements, to mobile camera phone 133 for presentation on the display of mobile camera phone 133. Analytics System 145 will continue to update mobile camera phone 133 until user 130 terminates application 132 or uses application 132 to capture another video or audio sample.

In another alternative embodiment, mobile camera phone 133 sends sample ID 137 via Internet 136 to Network Identification 139. Network Identification 139 sends Confirmed ID 138 to Analytics System 145. Analytics System 145 obtains information from EPG 141 and Betting Data 143, and formats and sends display information 150, which includes relevant data with graphical elements, to mobile camera phone 133 for presentation on the display of mobile camera phone 133. Analytics System 145 will continue to update mobile camera phone 133 until user 130 terminates application 132 or uses application 132 to capture another video or audio sample.

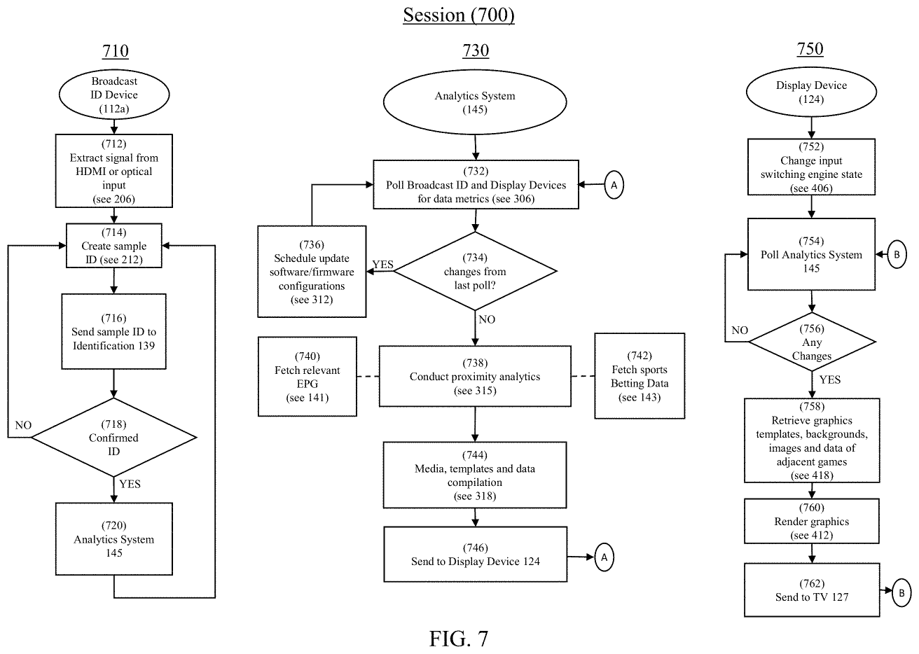

FIG. 7 is a collection of flowcharts of a session 700 showing processes performed by Broadcast ID Device 112a, Analytics System 145, and Display Device 124.

Process 710 is performed by Broadcast ID Device 112a.

In operation 712, signal extractor 206 extracts a sample of signal 110a. Signal 110a may be in HDMI or optical format, or a digital audio or analog audio signal.

In operation 714, signal sample and analyzer 212 creates sample ID 137.

In operation 716, Broadcast ID Device 112a sends sample ID 137 to Network Identification 139.

In an alternative embodiment, in operation 716, Broadcast ID Device 112a sends sample ID 137 to Analytics System 145.

In operation 718, Broadcast ID Device 112a checks for a response, i.e., confirmed ID 138, from Network Identification 139. If there is no response, process 710 loops back to operation 714. If there is a response, i.e., confirmed ID 138, process 710 proceeds to operation 720.

In an alternative embodiment, in operation 718, Broadcast ID Device 112a checks for a response, i.e., confirmed ID 138, from Analytics System 145. If there is no response, process 710 loops back to operation 714. If there is a response, i.e., confirmed ID 138, process 710 proceeds to operation 720.

In operation 720, Broadcast ID Device 112a sends confirmed ID 148 to Analytics System 145.

In an alternative embodiment, in operation 720, Analytics System 145 confirms ID 148.

Process 730 is performed by Analytics System 145.

In operation 732, venue device monitoring engine 306 polls Broadcast ID Device 112a and Display Device 124 for data metrics.

In operation 734, Analytics System 145 considers whether there are any device issues or changes from the last poll. If there is a change, process 730 proceeds to operation 736. If there is no change, process 730 proceeds to operation 738.

In operation 736, Analytics System 145 schedules update software/firmware configurations based on software/firmware configurations 312. Process 730 then loops back to operation 732.

In operation 738, proximity analytics engine 315 conducts proximity analytics, which includes (a) in operation 740, fetching relevant program information from EPG 141, and (b) in operation 742, fetching sports betting information from Betting Data 143. Process 730 then proceeds to operation 744.

In operation 744, Analytics System 145 compiles media, templates and data from media, templates, and data storage 318.

In operation 746, Analytics System 145 sends display information 150 to Display Device 124, and then process 730 loops back to operation 732.

Process 750 is performed by Display Device 124.

In operation 752, input switching engine 406 is set to select data, via input 2, from media player 415.

In operation 754, Display Device 124 polls Analytics System 145.

In operation 756, Display Device 124 considers whether there is any change in data, i.e., in display information 150, from Analytics System 145. If the is no change in data, process 750 loops back to operation 754. If there is a change in data, i.e., new display information 150, process 750 proceeds to operation 758.

In operation 758, Display Device 124 retrieves graphics templates, backgrounds, images, and data for games from media and data storage 418.

In operation 760, graphics engine 412 renders graphics.

In operation 762, Display Device 124 sends content to TV 127, and process 750 then loops back to operation 754.

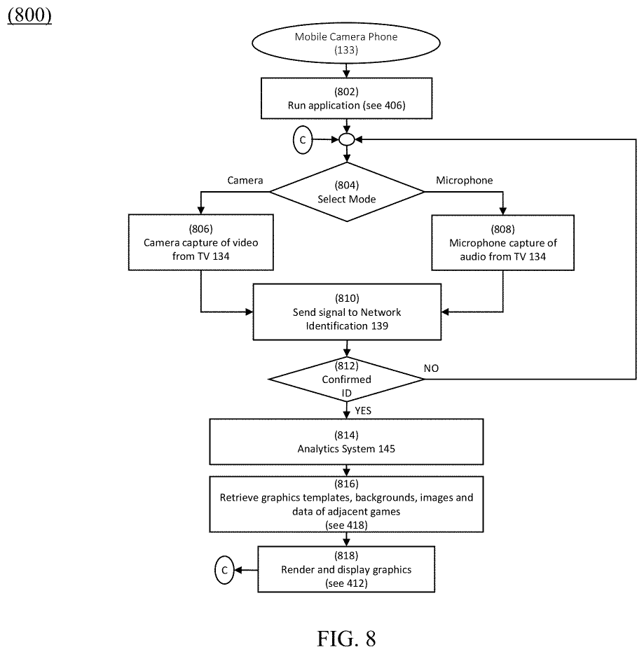

FIG. 8 is a flowchart of a process 800 performed by mobile camera phone 133 in accordance with application 132. For process 800, we assume that mobile camera phone 133 is being operated by user 130 watching TV 134 in home 135. However, process 800 could also be performed with user 130 watching TV 115a in venue 103.

Application 132 performs several operations that are analogous to operations performed by Broadcast ID Device 112a, and several operations that are analogous to operations performed by Display Device 124.

In operation 802, application 132 is initiated and set to present content on the display of mobile camera phone 133. Operation 802 is analogous to that of input switching engine 406 being configured to select data from media player 415.

As mentioned above, mobile camera phone 133 has a camera and a microphone.

In operation 804, application 132 prompts user 130 to select either a camera or a microphone to capture content from TV 134. If user 130 selects “camera”, process 800 proceeds to operation 806. If user 130 selects “microphone”, process 800 proceeds to operation 808.

In operation 806, user 130 directs the camera of mobile camera phone 133 at TV134, and the camera captures video from TV 134, and application 132 prepares sample ID 137 from the video. Process 800 then proceeds to operation 810.

In operation 808, user 130 positions the microphone of mobile camera phone 133 to capture audio from TV 134, and application 132 prepares sample ID 137 from the audio. Process 800 then proceeds to operation 810.

In operation 810, mobile camera phone 133 sends sample ID 137 to Network Identification 139.

In an alternative embodiment, in operation 810, mobile camera phone 133 sends Sample ID 137 to Analytics System 145.

In operation 812 mobile camera phone 133 checks for a response, i.e., confirmed ID 138, from Network Identification 139. If there is no response, process 800 loops back to operation 804. If there is a response, i.e., confirmed ID 138, process 800 proceeds to operation 814.

In an alternative embodiment, in operation 812, mobile camera phone 133 checks for a response, i.e., confirmed ID 138, from Analytics System 145. If there is no response, process 800 loops back to operation 804. If there is a response, i.e., confirmed ID 138, process 800 proceeds to operation 814.

In operation 814, mobile camera phone 133 prepares and sends confirmed ID 148 to Analytics System 145, and in return, receives display information 150.

In an alternative embodiment, in operation 814, mobile camera phone 133 receives confirmed ID 148 and display information 150 from Analytics System 145.

In operation 816, mobile camera phone 133, based on display information 150, retrieves graphics templates, backgrounds, images, and data of games from a storage, analogous to media and data storage 418.

In operation 818, mobile camera phone 133 presents, on its display, the graphics templates, backgrounds, images and data of games, and process 800 then loops back to operation 804.

In review, Analytics System 145 performs a process that includes (a) receiving, in confirmed ID 148, an identification of a television (TV) network (b) obtaining, from EPG 141, a descriptor of a sporting event that is being transmitted by the TV network, (c) obtaining, from Betting Data 143, gambling statistics concerning the sporting event, and (d) sending the gambling statistics, in display information 150, to a device, e.g., display device 124 or mobile camera phone 133, for presentation on a target display, e.g., the display of TV 127 or the display of mobile camera phone 133.

The sporting event may be presented on a first display, e.g., the display of TV 115a or the display of TV 134, and the target display may be a second display, e.g., the display of TV 127 or the display of mobile camera phone 133.

The first display may be a component of a first TV, e.g., TV 115a, and the second display may be a component of a second TV, e.g., TV 127.

The second display may be a component of a mobile communication device, e.g., mobile camera phone 133.

Consider a case in which the above-noted TV network is a first TV network, the sporting event is a first sporting event, and the gambling statistics are first gambling statistics, and that the first sporting event is being presented on a first display, e.g., the display of TV 115a. The process may further include (e) receiving in another instance of confirmed ID 148, an identification of a second television (TV) network, (f) obtaining, from EPG 141, a descriptor of a second sporting event that is being transmitted by the second TV network and being presented on a second display, e.g., the display of TV 115n, (g) obtaining, from Betting Data 143, second gambling statistics concerning the second sporting event and (h) sending the second gambling statistics, in display information 150, to device 124, for presentation on the target display e.g., the display of TV 127. Thus, the target display is a third display. The process may also include receiving data that indicates a location of the first display, data that indicates a location of the second display, and data that indicates a location of the third display, and formatting the first gambling statistics and the second gambling statistics for presentation on the third display in a manner that indicates the location of the first display and the location of the second display relative to the location of the third display.

Each of Broadcast ID Device 112a, Analytics System 145, Display Device 124, and mobile camera phone 133 includes electronic circuitry that performs operations to execute methods or processes described herein. The circuity may be implemented with any or all of (a) discrete electronic components, (b) firmware, or (c) a programmable circuit that includes a processor and a memory. Such a processor is an electronic device configured of logic circuitry that responds to and executes instructions. Such a memory is a tangible, non-transitory, computer-readable storage device encoded with a computer program. In this regard, the memory stores data and instructions, i.e., program code, that are readable and executable by the processor for controlling operations of the processor. The memory may be implemented in a random-access memory (RAM), a hard drive, a read only memory (ROM), or a combination thereof.

Additionally, the program code may be configured on a storage device for subsequent loading into the memory. Such a storage device is a tangible, non-transitory, computer-readable storage device, and examples include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random-access memory, and (i) an electronic storage device coupled the components of system 100 via a data communication network, such as Internet 136.

The techniques described herein are exemplary, and should not be construed as implying any particular limitation on the present disclosure. It should be understood that various alternatives, combinations and modifications could be devised by those skilled in the art. For example, operations associated with the processes described herein can be performed in any order, unless otherwise specified or dictated by the operations themselves. The present disclosure is intended to embrace all such alternatives, modifications and variances that fall within the scope of the appended claims.

The terms “comprises” or “comprising” are to be interpreted as specifying the presence of the stated features, integers, operations or components, but not precluding the presence of one or more other features, integers, operations or components or groups thereof. The terms “a” and “an” are indefinite articles, and as such, do not preclude embodiments having pluralities of articles.

What is claimed is:

1. A process comprising:
receiving an identification of a television (TV) network;
obtaining a descriptor of a sporting event that is being transmitted by said TV network;
obtaining gambling statistics concerning said sporting event; and
sending said gambling statistics to a device for presentation on a target display.

2. The process of claim 1, wherein said sporting event is being presented on a first display, and said target display is a second display.

3. The process of claim 2, wherein said first display is a component of a first TV, and said second display is a component of a second TV.

4. The process of claim 2, wherein said second display is a component of a mobile communication device.

5. The process of claim 1,
wherein said TV network is a first TV network, said sporting event is a first sporting event, and said gambling statistics are first gambling statistics,
wherein said first sporting event is being presented on a first display,
wherein said process further comprises:
receiving an identification of a second television (TV) network;
obtaining a descriptor of a second sporting event that is being transmitted by said second TV network and being presented on a second display;
obtaining second gambling statistics concerning said second sporting event; and
sending said second gambling statistics to said device for presentation on said target display, and
wherein said target display is a third display.

6. The process of claim 5, further comprising:
receiving data that indicates a location of said first display, data that indicates a location of said second display, and data that indicates a location of said third display; and
formatting said first gambling statistics and said second gambling statistics for presentation on said third display in a manner that indicates said location of said first display and said location of said second display relative to said location of said third display.

7. A system comprising:
a processor; and
a memory that contains instructions that are readable by said processor to cause said processor to perform operations of:
receiving an identification of a television (TV) network;
obtaining a descriptor of a sporting event that is being transmitted by said TV network;
obtaining gambling statistics concerning said sporting event; and
sending said gambling statistics to a device for presentation on a target display.

8. The system of claim 7, wherein said sporting event is being presented on a first display, and said target display is a second display.

9. The system of claim 8, wherein said first display is a component of a first TV, and said second display is a component of a second TV.

10. The system of claim 8, wherein said second display is a component of a mobile communication device.

11. The system of claim 7,
wherein said TV network is a first TV network, said sporting event is a first sporting event, and said gambling statistics are first gambling statistics,
wherein said first sporting event is being presented on a first display,
wherein said operations further include:
receiving an identification of a second television (TV) network;
obtaining a descriptor of a second sporting event that is being transmitted by said second TV network and being presented on a second display;
obtaining second gambling statistics concerning said second sporting event; and
sending said second gambling statistics to said device for presentation on said target display, and
wherein said target display is a third display.

12. The system of claim 11, wherein said operations further include:
receiving data that indicates a location of said first display, data that indicates a location of said second display, and data that indicates a location of said third display; and
formatting said first gambling statistics and said second gambling statistics for presentation on said third display in a manner that indicates said location of said first display and said location of said second display relative to said location of said third display.

13. A storage device comprising instructions that are readable by a processor to cause said processor to perform operations of:
receiving an identification of a television (TV) network;
obtaining a descriptor of a sporting event that is being transmitted by said TV network;
obtaining gambling statistics concerning said sporting event; and
sending said gambling statistics to a device for presentation on a target display.

14. The storage device of claim 13, wherein said sporting event is being presented on a first display, and said target display is a second display.

15. The storage device of claim 14, wherein said first display is a component of a first TV, and said second display is a component of a second TV.

16. The storage device of claim 14, wherein said second display is a component of a mobile communication device.

17. The storage device of claim 13,
wherein said TV network is a first TV network, said sporting event is a first sporting event, and said gambling statistics are first gambling statistics,
wherein said first sporting event is being presented on a first display,
wherein said operations further include:
receiving an identification of a second television (TV) network;
obtaining a descriptor of a second sporting event that is being transmitted by said second TV network and being presented on a second display;
obtaining second gambling statistics concerning said second sporting event; and
sending said second gambling statistics to said device for presentation on said target display, and
wherein said target display is a third display.

18. The storage device of claim 17, wherein said operations further include:
receiving data that indicates a location of said first display, data that indicates a location of said second display, and data that indicates a location of said third display; and
formatting said first gambling statistics and said second gambling statistics for presentation on said third display in a manner that indicates said location of said first display and said location of said second display relative to said location of said third display.
